(19) United States
(12) Patent Application Publication
(10) Pub. No.: US 2008/0066181 A1
(43) Pub. Date: Mar. 13, 2008

(54) DRM aspects of peer-to-peer digital content distribution

(75) Inventors: Ryan A. Haveson, Monroe, WA (US); Max G. Morris, Seattle, WA (US); Darren R. Davis, Woodinville, WA (US); Hubert Van Hoof, Seattle, WA (US); Kevin Lau, Sammamish, WA (US); Robert Hildreth, Bellevue, WA (US); Clifford P. Strom, Sammamish, WA (US); Scott Plette, Seattle, WA (US); Alex McKelvey, Seattle, WA (US); Derek Broes, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/516,879

(22) Filed: Sep. 7, 2006

(51) Int. Cl. H04N 7/16

(52) U.S. Cl. 726/26

(57) ABSTRACT

Aspects of peer-to-peer distribution of digital content items protected by predetermined intellectual property rights are described. The digital content items are distributed between a source communication device operated by a source entity and a proximate sink communication device operated by a sink entity, via a peer-to-peer communication session (established based on a digital identity associated with the source entity) between the source and sink devices. The source device, the sink device, and/or a network service provider arranges for a digital license granting one or more rights to an entity under one or more of the predetermined intellectual property rights to be distributed to the sink communication device. Data regarding distribution of the digital license is collected and used, among other things, to trigger e-commerce events such as billing events and consideration transfers.

### BACKGROUND

Digital content (such as video, audio, images, data, playlists, multimedia content, text, documents, spreadsheets, and electronic books for example) is acquired and consumed using an ever-increasing variety of devices. The content may be used for professional or leisure purposes. Some examples of devices used to acquire or consume digital content include personal computers (“PCs”), personal digital assistants, portable digital media players, and mobile phones. Specific digital content tends to be consumed by individuals with common traits, interests, or job functions. Because such individuals often gather together in public and private areas such as educational settings, employment settings, restaurants, cities/neighborhoods, shopping areas, cultural attractions, recreational areas, and the like, there is a high likelihood that digital content interesting to or needed by a particular person is physically located on a device (which may belong to someone else) somewhere near that person. Likewise, people with common interests create virtual locations within information networks in which they might congregate. Examples of how these locations may be defined include but are not limited to contacts within an e-mail program, a virtual workgroup hosted on a corporate computer, buddy lists within an instant messaging program, participants in an online forum hosted on a website, or in other online community spaces. As with people that share proximity in the physical world having similar interests, people that share proximity within the virtual world also tend to have similar interests. Within the virtual world people often feel that other participants with whom they interact are as immediate to them as someone sitting physically nearby. Again there is a high likelihood that digital content interesting to a particular person is located on a device somewhere virtually near that person.

Increasingly, devices are equipped with connectivity features that allow the devices to communicate with other devices over networks. Wide area networks (“WANs”) are wireless or wired geographically dispersed networks generally covering geographic regions of more than a few hundred meters. The Internet is one example of a WAN. Local-area networks (“LANs”) are wireless or wired networks that facilitate the transmission or receipt of information within relatively small physical areas surrounding a device or an entity such as a person or a business (generally, up to a few hundred meters).

One type of LAN is a wireless LAN (“WLAN”). WLANs are generally defined by the air interface protocol(s) that wireless-enabled devices use for communication with wireless access nodes serving physical areas, which are referred to as “hotspots”. Currently popular WLAN air interface protocols include the Wireless Fidelity (“WiFi”) series of protocols and the HiperLAN series of protocols.

Another type of LAN is a personal LAN (“PAN”). A PAN represents any technology or system usable for direct communication between processing locations close to a particular person (for example, up to a few meters). Generally, an access point is not required to enable such communication, but PAN technologies or systems may optionally be used to connect to other LANs or WANs via access points. Wireless cable replacement technologies, which are generally defined by the air interface protocol(s) that wireless-enabled devices use for communication, may be used to establish PANs. Currently popular cable replacement air interface protocols include Bluetooth, Wireless USB, and various proprietary protocols. The WiFi series of protocols may also be used to establish wireless cable replacement topologies. Near field communication (“NFC”) technologies and devices may also be used to form PANs.

Increasingly, content acquisition and/or consumption devices are being enabled to participate in communication built on WAN, LAN, or PAN technologies. In many cases these devices are able to interact with other physically or virtually local devices. As networking opportunities become ubiquitous, implementing network-based peer-to-peer content distribution techniques operable with physically or virtually local communication devices would allow individuals to easily acquire or consume interesting digital content. Such peer-to-peer distribution techniques could also reduce content distribution costs (such as marketing costs and distribution infrastructure costs) incurred by entities such as employers, content and/or service providers. Such entities, however, are also generally concerned with reducing the likelihood of illegal sharing of digital content that is protected by enforceable intellectual property rights of third parties, such as patent copyrights, patent rights, trademark rights, or trade secret rights.

Although various digital rights management (“DRM”) technologies, techniques and/or systems have been developed to protect the intellectual property rights of entities in digital content (for example, content encryption schemes, client-server authentication/authorization techniques, and key/ticket-based authentication/authorization systems), known DRM implementations are not generally equipped for use with, or to support e-commerce models that encourage the use of, peer-to-peer digital content distribution systems or techniques.

It is therefore desirable to provide cost-effective, flexible DRM options for accessing, managing, and encouraging the legal distribution of a wide variety of digital content using peer-to-peer communication.

It will be appreciated, however, that the claimed subject matter is not limited to implementations that solve any or all of the disadvantages of specific DRM systems or peer-to-peer digital content sharing systems.

### SUMMARY

Methods, systems, apparatuses, and articles of manufacture discussed herein involve aspects of digital rights management, consideration management, and access management for peer-to-peer digital content distribution transactions. Such distribution transactions involve the distribution of digital content items, which are protected by one or more intellectual property rights, via portable or non-portable communication devices such as mobile phones, personal digital assistants, personal computers, and personal audio or video players.

In general, particular digital content items stored on a computer-readable memory accessible via a source communication device operated by a source entity are identified. The digital content item(s) are available for distribution, or have been distributed, via a peer-to-peer communication session between the source communication device and a physically, virtually, and/or logically proximate sink communication device, which is operated by a sink entity. The source communication device, the sink communication device, and/or a network service provider arranges for a digital license to be distributed to the sink communication device. The service provider may provide network-based services to the source entity or the sink entity, or the service provider may be an independent third party.

A digital license is an electronic item or technique operative to grant one or more rights to an entity under one or more intellectual property rights protecting a digital content item. Examples of grants under intellectual property rights include the rights granted under copyrights to use, reproduce, or distribute a particular digital content item in accordance with certain business rules. Data regarding distribution of digital licenses is collected and used, among other things, to trigger e-commerce events such as consideration transfers. Consideration transfers include but are not limited to exchanges of redeemable articles, promises to pay money, and promises to perform services. Consideration may be authorized to be provided via the sink communication device (for example, in response to a billing event, promises to pay money, view advertising, or the redemption of articles such as reward points may occur via the sink communication device) and/or received via the source communication device (for example, after successful distribution of digital content, articles such as reward points or money may be received via the source communication device).

Options for providing identity-based access to peer-to-peer digital content distribution transactions are also described. In one exemplary implementation, flexible, granular access to digital content items accessible via a source communication device is enabled when a particular identity associated with a sink entity and/or a sink communication device is selected for presentation to the source communication device. An identity includes one or more pieces of information about the subject of the identity that are asserted to be valid and are verifiable (for example, by the source communication device or a third party). Various identities/items of information may be presented by the sink communication device to achieve varying amounts of access to digital content items accessible via the source communication device.

In this manner, a wide variety of digital content is discoverable and distributable by communication devices and entities operating the devices, the intellectual property rights of third parties in the digital content are protected, and flexible e-commerce models that encourage distribution of digital content are supported.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter.

### BRIEF DESCRIPTION OF THE DRAWINGS

FIG. 1 is a simplified functional block diagram of a communication architecture over which peer-to-peer communications between a source communication device operable by a source entity and a sink communication device operable by a sink entity can occur.

FIG. 2 is a simplified functional block diagram of a system for peer-to-peer distribution of digital content.

FIG. 3 is a message sequence chart illustrating certain aspects of a method for peer-to-peer distribution of digital content between a source communication device and a sink communication device.

FIG. 4 is a message sequence chart illustrating certain additional aspects of the method shown in FIG. 3.

FIG. 5 is a simplified functional block diagram of an exemplary operating environment with which aspects of the system shown in FIG. 2 and/or the method illustrated in FIG. 3 may be used.

### DETAILED DESCRIPTION

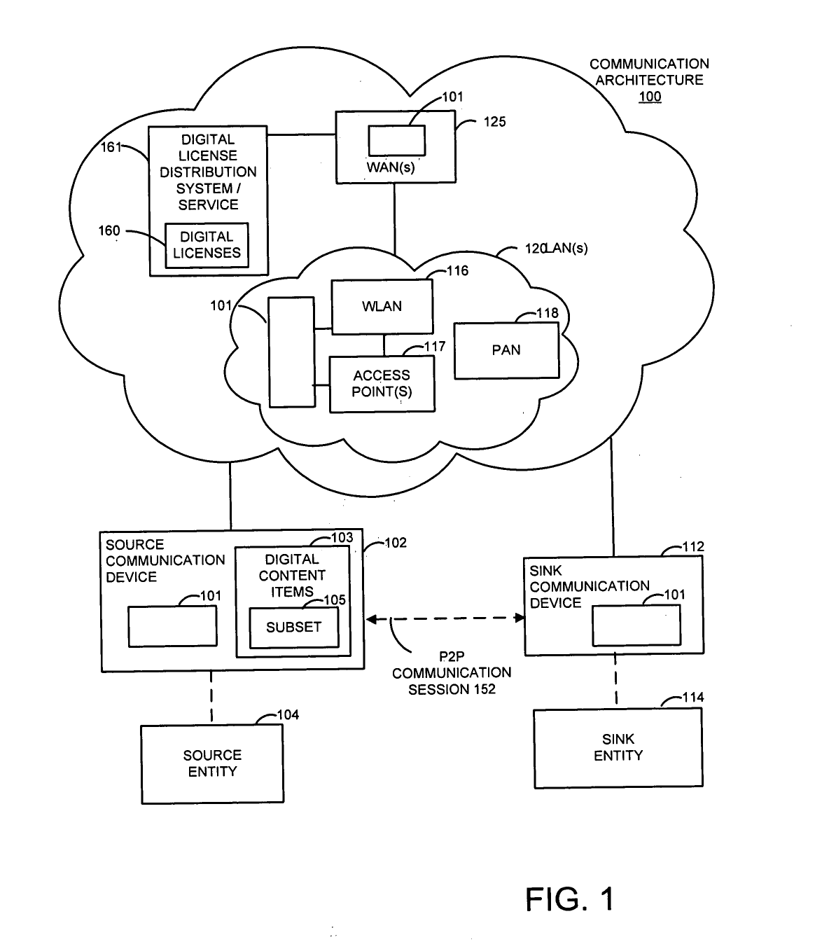

Turning to the drawings, where like numerals designate like components, FIG. 1 is a simplified functional block diagram of a communication architecture 100, which is used for establishing communications between a source communication device 102 and a sink communication device 112. Communication architecture 100 includes one or more networks, which may be wide area networks (“WANs”) 125 or local area networks (“LANs”) 120.

WANs 125 represent one or more geographically dispersed networks, generally covering geographic regions of more than a few hundred meters. Cellular networks, satellite networks, fiber-optic networks, co-axial cable networks, hybrid networks, copper wire networks, and over-the-air broadcasting networks are some examples of WANs. A WAN may be a packet-switched network or a circuit-switched network. A packet-switched network routes packets of data between equipment based on destination addresses of the equipment. The Internet is one example of a packet-switched WAN. In a circuit-switched network, a physical path or communication channel is dedicated to a connection between equipment. Examples of circuit-switched WANs are portions of the public switched telephone network (“PSTN”) and wireless communication networks such as certain cellular or satellite communication networks. It will be appreciated that WANs 125 may also serve as bridges to connect two or more separate local communication regions. Either source communication device 102 or sink communication device 112 may be present in one of these separate local communication regions. Further, given established networking technologies it is possible to consider that source communication device 102 and sink communication device 112 are within the same virtual communication region that may have behavior and properties analogous to a local communication region.

One type of LAN 120 is a wireless local area network (“WLAN”) 116, accessed by one or more access points 117. Another type of LAN 120 is a personal area network (“PAN”) 118, such as a wireless cable replacement system that allows direct communication between local devices. LANs are generally established within a particular local communication region (not shown). A local communication region is a relatively small physical area (for example, up to a few hundred meters) served by WLAN 116 and/or PANs 118 within which local communications such as wireless communications are established between nodes. It will be appreciated that the physical boundaries of a local communication region may be defined by dynamic parameters such as signal strength, access point location, bridging capabilities of WANs 125, and relationships between network operators, among other parameters. It will also be appreciated that the physical boundaries of a local communication region may be different for WLAN 116 and PANs 118 and those bridged by WANs 125. Multiple communication regions may exist with various amounts of overlapping coverage (or no overlapping coverage).

WLAN 116 represents one or more local area networks serving a particular local communication region. A WLAN is generally identified by the air interface protocol(s) used for communication between nodes therein. A node is a processing location within WLAN that has a unique address (such as a media access control (“MAC”) address or an Internet Protocol (“IP”) address). Nodes may be fixed (for example, access points 117 (discussed further below) or mobile (for example, communication devices carried by people within a local communication region). Currently popular WLAN air interface protocol(s) include the Wireless Fidelity (“WiFi”) series of protocols promulgated by the Institute of Electrical and Electronics Engineers (“IEEE”), the HiperLAN series of protocols developed by the European Telecommunications Standards Institute, and Bluetooth protocols. It will be appreciated that any air interface protocol now known or later developed by be used within WLAN 116.

Access point 117 is a physical or logical element that provides a point of entry, such as a communication hub, into infrastructure or services associated with WLAN 116 and/or WAN 125, accessible by communication equipment operating within a local communication region. Internal arrangements, architectures and principles of operation of access points are well known. Although one access point 117 is shown, it will be appreciated that multiple access points 117 may serve a local communication region.

PAN 118 represents any technology or system usable for direct communication between processing locations close to a particular person. Access point(s) 117 are not required to enable such communication, but PAN technologies or systems may optionally be used to connect to other LANs 120 or to WANs 125. The reach of a PAN is generally a few meters. Most wireless PANs utilize some form of wireless cable replacement technology. Wireless cable replacement technologies are generally identified by the air interface protocols used for communication between processing locations. Currently popular air interface protocols include Bluetooth, Wireless USB, and various proprietary protocols. The WiFi series of protocols may also be used to create wireless cable replacement topologies. Near field communication (“NFC”) technologies and devices may also be used to form PANs.

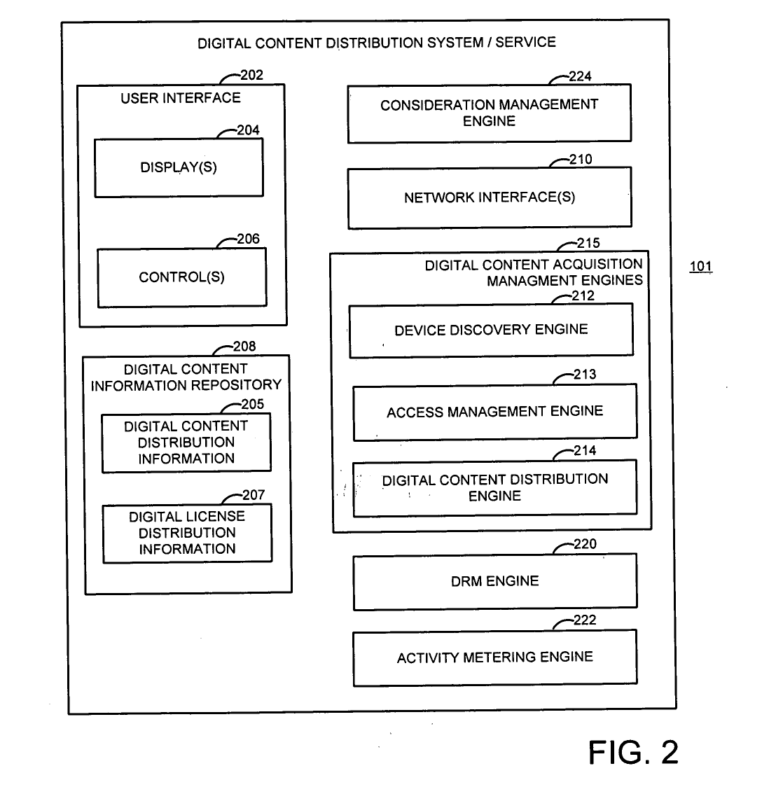

Digital content distribution system/service 101 (discussed further below, in connection with FIG. 2) facilitates distribution of digital content between a source communication device 102 operated by a source entity 104 and a proximate sink communication device 112 operated by a sink entity 114 via a peer-to-peer (“P2P”) communication session 152. As shown, aspects of digital content distribution system/service 101 are hosted by processing locations associated with various network-side entities, such as within WAN 125, WLAN 116, or access points 117, and aspects of digital content distribution system/service 101 are also hosted by source communication device 102 and sink communication device 112.

P2P communication session 152 represents any peer-to-peer physical or virtual connection between source communication device 102 and sink communication device 112. Although in practical application within local communication regions P2P communication session 152 may often be wireless, it will be appreciated that P2P communication session 152 may be established via WANs, and that irrespective of the type of network(s) used, P2P communication session 152 may be wired, wireless, or any combination thereof. It will also be appreciated that the communication technologies and protocols used within a local communication region are not immediately compatible. For example, devices such as source communication device 102 and sink communication device 112 operable within a particular local communication region may not necessarily be able to communicate directly with each other if the devices do not support the same or compatible communication protocols. Additionally, source communication device 102 and sink communication device 112 may be physically located within different instances of a LAN 120 bridged by a WAN 125. It will be understood that the user impact of such incompatibilities may be managed by applying various wired or wireless bridging techniques between communication protocols, which are generally known to one skilled in the art, to enable a communication session such as P2P communication session 152 to be established even when participating devices do not support the same communication protocols or same LAN 120.

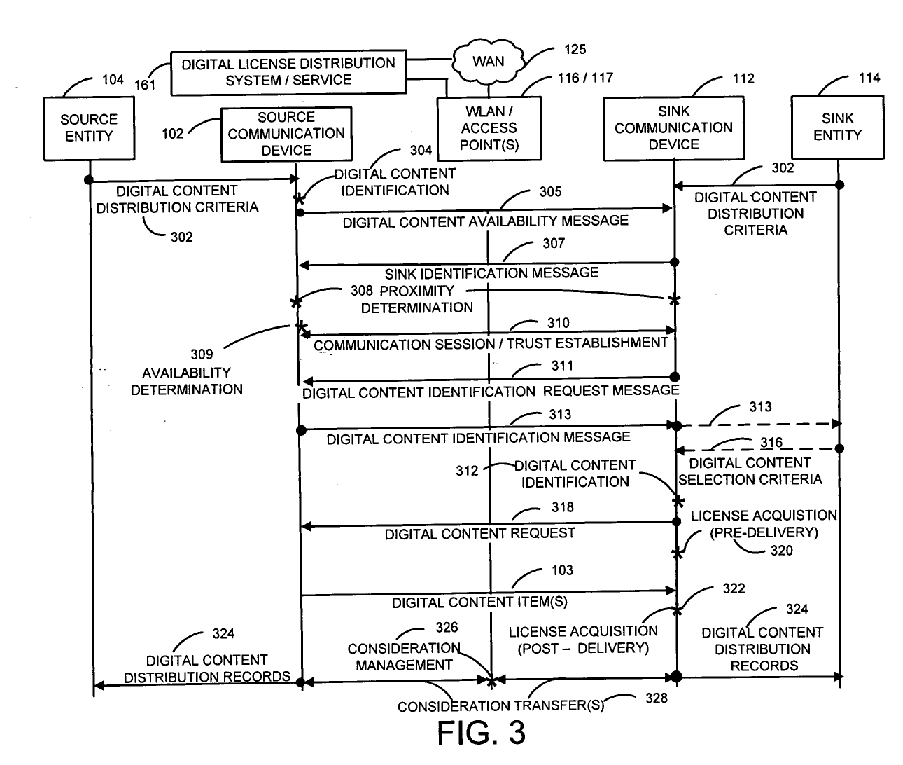

Source communication device 102 is any electronic device (or any physical or logical element of such an electronic device, either standing alone or included in other devices), which is configured for communication via any network within communication architecture 100 (for example, using one or more WANs 125 and/or LANs 120, such as WLAN 116 or a particular PAN 118 or both) and which is responsive to source entity 104. Source entity 104 is a person or business operating source communication device 102. Among other things, source communication device 102 facilitates the distribution of (generally, the transmission of) one or more digital content items 103 to sink communication device 112 via P2P communication session 152 and digital content distribution system/service 101. Subset 105 represents one or more digital content items 103 available for distribution via P2P communication session 152. It will be understood that subset 105 may include one, some or all digital content items 103. The derivation of subset 105, which may occur in a wide variety of ways, is discussed further below, in connection with FIG. 3.

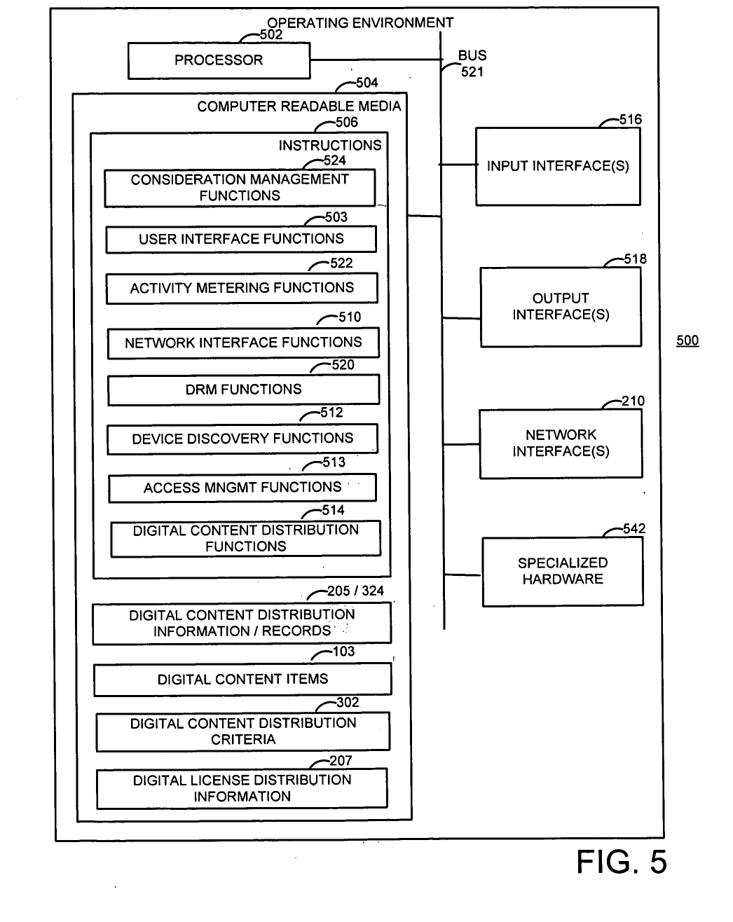

Digital content items 103 represent any item stored in a digital format, including but not limited to digital media items. Examples of digital content items 103 include but are not limited to audio files, video files, image files, text files, document files, spreadsheet files, multimedia files, data files, and playlists and metadata associated with these items. Metadata is any information, in any form or format, about the digital items. Examples of metadata include artist information, owner information, publication date, photographs, graphics, descriptive text, file size information, and the like. Digital content items 103 are generally stored on computer-readable media, such as computer-readable media 504 within a particular communication device (discussed further below in connection with FIG. 5), but may also be stored on remote computer-readable media. Digital content items 103 may exist in any available formats or protocols or combinations thereof, such as portable network graphics (“PNG”), joint photographic experts group (“JPEG”), moving picture experts group (“MPEG”), multiple-image network graphics (“MNG”), audio video interleave (“AVI”), extensible markup language (“XML”), hypertext markup language (“HTML”), Adobe Acrobat (“PDF”), Microsoft® Word (“DOC”), Microsoft® Excel (“XLS”), extensible HTML (“XHTML”), MP3, WAV, WMA, WMV, ASF, or any format via which digital data may be provided in real-time or streamed.

Digital content items 103 may be protected by one or more enforceable intellectual property rights of one or more third parties, such as copyrights, patent rights, trademark rights, or trade secret rights. Digital licenses 160 (shown in connection with digital license distribution system/service 161, which is discussed further below) are electronic items or techniques operative to grant one or more rights to an entity under one or more intellectual property rights protecting particular digital content items 103. Examples of grants under intellectual property rights include the rights granted under copyrights to use, reproduce, or distribute a particular digital content item. Rights granted under intellectual property rights may also be restricted in various ways, for example, in accordance with business rules, which reflect intellectual property rights holders' preferences regarding how digital content items are distributed or used, to whom they are distributed, and when or where they are distributed or used. Examples of business rules include but are not limited to limits on the number of times a particular digital content item may be reproduced, rendered, or distributed, or the type of rendering device that may be used to render the digital content item (it may often be necessary to re-encode digital content items for use on different rendering devices, and certain business rules may restrict re-coding events). In one example, limited licenses (such as preview licenses) may grant rights to render degraded versions of content, render certain portions of content, or rights to render content for short periods of time or a limited number of times. Business rules may be implemented using expressions having logical references to variables. Boolean operands such as “AND,” “OR,” and “NOT”, along with other operands or types thereof, may be used to define such expressions. It will be appreciated that virtually unlimited business rules and combinations thereof are definable. Business rules may be predetermined, or may be modified based on operation of digital content distribution system/service 101 or digital license distribution system/service 161. In one exemplary implementation, digital licenses 160 contain digital keys used to unlock encrypted digital content files. It will be appreciated, however, that digital licenses 160 may be implemented in other manners.

Digital license distribution system/service 161 represents any digital rights management (“DRM”) system or technique operable to enable acquisition of digital licenses 160 by source communication device 102 or sink communication device 112. Digital license distribution system/service 161 is generally accessible via processing locations within WAN(s) 125 or LAN(s) 120. In one exemplary implementation, aspects of digital license distribution system/service 161 are implemented using one or more server- or client-side applications having features or technologies associated with Microsoft® Windows Media® digital rights management (hereinafter referred to as “WMDRM”) systems that enable over-the-air acquisition of digital licenses 160 by communication devices. Further details regarding operational implementations of server-side and client-side WMDRM applications are discussed below, in connection with FIGS. 2 and 3.

Sink communication device 112 is any electronic device (or any physical or logical element of such an electronic device,.either standing alone or included in other devices), which is configured for communication via any network within communication architecture 100 (for example, using one or more WANs 125 and/or LANs 120, such as WLAN 116 or a particular PAN 118 or both) and which is responsive to sink entity 114. Sink entity 114 is a person or business operating sink communication device 112. Further, sink communication device 112 is capable of establishing P2P communication session 152 with source communication device 102 either directly or through the use of intermediate bridging technology. Among other things, sink communication device 112 facilitates the distribution of (generally, the receipt of) subset 105 of digital content items 103 on behalf of sink entity 114 via P2P communication session 152.

With continuing reference to FIG. 1, FIG. 2 is a simplified functional block diagram of digital content distribution system/service 101, which is a peer-to-peer digital content distribution system and is hereinafter referred to as “P2P Content Distribution System” 101. P2P Content Distribution System 101 is usable to facilitate the distribution of selected digital content items 103 within subset 105 between source communication device 102 and sink communication device 112 via communication session 152, and to facilitate the distribution of digital licenses 160 associated with digital content items 103 within subset 105 to sink communication device 112.

P2P Content Distribution System 101 includes a user interface 202, which further includes display(s) 204 and control(s) 206; a digital content information repository 208, which stores, among other things, digital content distribution information 205 and digital license distribution information 207; network interface(s) 210; digital content acquisition management engines 215, which include a device discovery engine 212, an access management engine 213, and a digital content distribution engine 214; a digital rights management engine 220; an activity metering engine 222; and a consideration management engine 224. In general, design choices dictate how specific functions of P2P Content Distribution System 101 are implemented. Such functions may be implemented using hardware, software or firmware, or combinations thereof.

User interface 202 represents the combination of display(s) 204 and control(s) 206 that define the way a user interacts with a particular device, such as sink communication device 102 or source communication device 112. Display(s) 204 are used to receive input from, or provide output to, a user. An example of a physical display is a monitor device. An example of a logical display is a data organization technique (for example, a window (such as an Internet browser window), a menu, or a layout thereof). Control(s) 206 facilitate the receipt of input from a user. An example of a physical control is an input device such as a remote control, a display, a mouse, a pen, a stylus, a trackball, a keyboard, a,microphone, or a scanning device. An example of a logical control is a data organization technique (for example, a window, a menu, or a layout thereof) via which a user may issue commands. It will be appreciated that the same physical device or logical construct may function as an interface for both inputs to, and outputs from, a user.

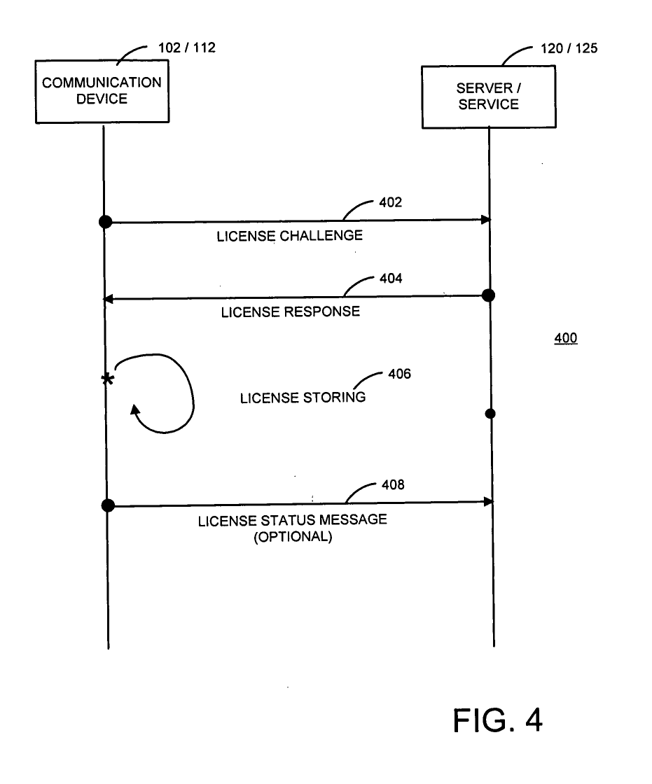

Digital content information repository 208 represents general data storage capability for information relating to distribution of digital content items 103 via P2P communication session 152, including but not limited to digital content distribution information 205 and digital license distribution information 207. Digital content distribution information represents data regarding distribution of subset 105 of digital content items 103, including but not limited to: identifying information associated with digital content items 103, subset 105 or aspects of distribution transactions relating thereto (such as unique content identifiers, metadata regarding content, original content source identifiers, content distribution history, network service providers of source and sink entities, location of distribution transaction, and consideration transfers); digital content distribution criteria 302 (discussed further below, in connection with FIG. 3); digital content distribution records 324 (also discussed in connection with FIG. 3); and data storage elements, such as virtual folders or other elements used to coordinate distribution of selected digital content item(s) within subset 105. Digital license distribution information 207 represents data regarding distribution of digital licenses 160, including but not limited to: identifying information associated with digital licenses 160 or aspects of distribution transactions relating thereto, such as statuses associated with distribution of digital licenses 160 (discussed in connection with FIG. 4) and metering information associated with exercise of the rights granted by digital licenses 160 (also discussed in connection with FIG. 4). Digital content information repository 208 may be implemented using various types and arrangements of computer-readable media 504 (discussed further below, in connection with FIG. 5).

Network interface(s) 210 represent one or more physical or logical elements, such as connectivity devices or computer-executable instructions that enable communication between source communication device 102 and sink communication device 112 via one or more protocols or techniques (such as WAN 125 protocols or techniques, WLAN 116 protocols or techniques, or PAN 118 protocols or techniques). Information received at a given network interface may traverse one or more of the seven vertical layers of the OSI Internetworking Model: layer 1, the physical layer; layer 2, the data link layer; layer 3, the network layer; layer 4, the transport layer; layer 5, the session layer; layer 6, the presentation layer; and layer 7, the application layer.

Digital content acquisition management engines 215, which include a device discovery engine 212, an access management engine 213, and a digital content distribution engine 214, are configured to implement certain aspects of P2P digital content distribution transactions between potential participants in such transactions. Device discovery engine 212 discovers and determines the proximity of potential participants in the distribution transactions based on messaging between the potential participants. Messaging is accomplished via network interface(s) 210.

In one implementation, device discovery engine 212 implements one or more features of a wide-area or local-area networking service. Examples of local networking services are defined by the Universal Plug and Play peer-to-peer connectivity architecture (“UPnP™ Architecture”), which is a universal standard promulgated by the UPnP™ Forum, and by the Web Services Dynamic Discovery (“WS-Discovery”) protocol, which is a standard that defines how services are discovered (generally, using SOAP) on a network. Other now known or later developed local networking implementations are also possible, such as customized Bluetooth profiles, and Zero Configuration Networking (“ZeroConf”) techniques. Examples of wide area networking services include but are not limited to services such as instant messaging services, email services, short messaging services, chat room services, file exchange services, and the like. In environments when WANs are used, different implementations of device discovery engine 212 may be employed. For example, when WAN 125 is the Internet, the domain name system (“DNS”) servers may be employed. Alternately, programs involving data proxies or relays that enable devices on physically separate networks to discover and communication with each other may be employed.

The primary responsibility of the service implemented by device discovery engine 212 is to reply to requests for information from potential participants in P2P digital content distribution transactions. Device discovery engine 212 may also handle certain aspects of establishing P2P communication session 152 via network interface(s) 210, and may serve as a helper application to DRM engine 220 (discussed further below). Additional operational details regarding aspects of the service implemented by device discovery engine 212 are discussed below, in connection with FIG. 3.

Access management engine 213 is responsible for establishing a level of trust between two endpoints in a communication session, such as between source communication device 102 and sink communication device 112 in communication session 152, or between a communication device and a network-side entity in a client-server-type communication (such as a communication between sink communication device 112 and digital license distribution system/service 161). Establishment of trust may require specific services of other engines, such as device discovery engine 212, digital content distribution engine 214 (discussed further below), or DRM engine 220 (also discussed further below). There are numerous methods available for establishing trust between parties through authentication and authorization schemes. Examples of authentication and authorization schemes include but are not limited to user name and password schemes, Kerberos technologies, Microsoft® CardSpace™ technologies, proprietary authentication mechanisms, and other known or later developed implementations.

In general, however, access management engine 213 implements aspects of an identity management system in conjunction with such authentication and authorization schemes. The identity management system provides for: representing identities using pieces of information about the subject of the identity that the issuer (which may be the subject itself or another entity) asserts are valid (such pieces of information are referred to as “claims”); conducting communications between identity providers, relying parties, and identity subjects; and protocol(s) for handling claims. Aspects of the identity management system may be implemented using protocols of the Web Services architecture such as the WS-Trust protocol, the WS-MetadataExchange protocol, and the WS-SecurityPolicy protocol, or in other manners now known or later developed. In one exemplary implementation, sink communication device 112 facilitates selection of a particular identity associated with sink entity 114 and/or sink communication device 112 for presentation to source communication device 102 to achieve varying amounts of access to digital content items 103 accessible via source communication device 102. Operational details regarding aspects of the identity management system implemented by access management engine 213 are discussed below, in connection with FIG. 3.

Digital content distribution engine 214 handles the core functions of identification and distribution of digital content items 103 between source communication device 102 and sink communication device 112 via P2P communication session 152. Digital content distribution engine 214 may also handle certain aspects of establishing P2P communication session 152 via network interface(s) 210, and may serve as a helper application to DRM engine 220 (discussed further below).

Generally, digital content distribution engine 214 implements one or more features of a service for identifying, enumerating and exchanging objects between source communication device 102 and sink communication device 112. The service implemented by digital content distribution engine 214 may be discoverable via a property defined on the service implemented by the device discovery engine 212—the latter service could be configured to provide the IP address and port of the former service, for example.

In one exemplary implementation, the service implemented by digital content distribution engine 214 provides support for enumerating and/or exchanging objects using Media Transfer Protocol (“MTP”). In another exemplary implementation, the service provides support for a directory-based solution for enumerating and/or exchanging objects. Other now known or later developed file transfer and/or directory-based solutions are also possible.

DRM engine 220 handles the distribution of digital licenses 160 between digital license distribution system/service 161 and sink communication device 112. Distribution of digital license(s) 160 may occur before or after distribution of selected digital content items 103 within subset 105 between source communication device 102 and sink communication device 112. Generally, DRM engine 220 is implemented by one or more server- or client-side DRM applications that enable acquisition (including but not limited to over-the-air acquisition) of digital licenses 160 by communication devices. In a network-side implementation, DRM engine 220 may implement aspects of digital license distribution system/service 161. In a client-side implementation, DRM engine 220 enables downloading of licenses and generation/communication of statuses associated with receipt and/or use of licenses to a network-side entity. Alternate embodiments of client-side DRM engine 220 implementations may enable the creation and distribution of new or derivative digital licenses from source communication device 102 to sink communication device 112. Operational details of DRM engine 220 are discussed below, in connection with FIGS. 3 and 4.

Activity metering engine 222 manages the collection of metering data, which is information associated with the distribution of digital licenses 160 and exercise of rights granted by the digital licenses. Some general types of metering data are discussed herein, including but not limited to statuses generated when digital licenses are successfully received (for example, stored) by sink communication devices and data related to the use or distribution of digital content items 103 (such as how often a particular digital content item is reproduced, transcoded, distributed, or rendered). Specific network- and client-side implementations of activity metering engine 222, however, are beyond the scope of the subject matter discussed herein.

Consideration management engine 224 handles exchanges of consideration associated with distribution of digital content items 103 via P2P Content Distribution System 101 and/or distribution of digital licenses 160 via digital license distribution system/service 161. Consideration is something of value given by one party to another in exchange for an act or promise. Examples of consideration include but are not limited to promises to pay money (directly or indirectly, such as via cash, credit, or any type of account charge), promises to perform services (such as providing digital content or receiving advertising), or the providing or redemption of a redeemable article (which is anything, such as a certificate or points, issued with the expectation of being taken back by or on behalf of the issuer). Consideration transfers, such as the authorization for providing consideration effected by a sink entity via a sink communication device, or the receipt of consideration by a source entity via a source communication device, may be used to create flexible e-commerce models that encourage distribution of digital content. Aspects of the operation of consideration management engine 224 are discussed further below, in connection with FIG. 3.

With continuing reference to FIGS. 1 and 2, FIG. 3 is a message sequence chart illustrating certain aspects of a method for distributing digital content in a P2P manner. The method(s) illustrated in FIG. 3 may be implemented using computer-executable instructions executed by one or more general, multi-purpose, or single-purpose processors (exemplary computer-executable instructions 506 and processor 502 are discussed further below, in connection with FIG. 5). Unless specifically stated, the methods described herein are not constrained to a particular order or sequence. In addition, some of the described method or elements thereof can occur or be performed concurrently. As it is generally desirable to minimize time required to complete a particular distribution transaction, it will be understood that all of the described messaging need not occur in each distribution transaction, and the type, quantity, and implementation of specific messaging is a matter of implementation preference.

For exemplary purposes, one distribution transaction is discussed. The distribution transaction involves the distribution of selected digital content items within subset 105 between source communication device 102 operated by source entity 104 and sink communication device 112 operated by sink entity 114. For discussion purposes, it is assumed that source entity 104/source communication device 102 and sink entity 114/sink communication device 104 are operated within a local communication region served by a LAN. It will be appreciated, however, that source entity 104/source communication device 102 and sink entity 114/sink communication device 112 may be remotely located and communicate via one or more WANs (directly or using bridging technologies). It will also be appreciated that a particular communication device may function as both a source and a sink in the same transaction or in different transactions. The exemplary distribution transaction discussed is representative of a common transaction that would occur when two previously unaffiliated people using portable or non-portable communication devices such as wireless-enabled media players (referred to as “George” and “David”) are in proximity, such as in a WiFi hotspot in a coffee shop. It is assumed that George is the operator of source communication device 102 and that David is the operator of sink communication device 112. As used herein, the term “distribution” and forms thereof includes both client-side acts performed by communication devices (such as acts associated with transferring digital content by source communication device 102 or acts associated with receiving digital content by sink communication device 112) and network-side acts performed by local-area or wide-area networked servers or services (such as acts performed by providers of network service(s) to source communication device 102, providers of network service(s) to sink communication device 112, or independent third-party network service providers). It is appreciated that while the reference example makes use of a media player application and refers to media content this is not the only application or digital content type which may be distributed using P2P communication session 152. Other embodiments may use other viewer applications, such as a word processor or a spreadsheet program, to discover and share digital content of an appropriate type.

Initially (and optionally at appropriate points throughout the distribution transaction), source communication device 102 and sink communication device 112 receive and/or evaluate digital content distribution criteria 302. Digital content distribution criteria 302 represent any information usable by source communication device 102 or sink communication device 112 for decision-making regarding distribution of selected digital content item(s) within subset 105 between source communication device 102 and sink communication device 112. As such, digital content distribution criteria 302 are used to: identify item(s) within subset 105; select which item(s) within subset 105 are to be distributed; determine how selected item(s) within subset 105 are distributed; determine where or when selected item(s) within subset 105 are distributed (for example, before or after applicable digital content license(s) 160 are received); and determine to whom selected item(s) within subset 105 are distributed. As shown, digital content distribution criteria 302 are received from source entity 104 and sink entity 114 (via user interface 102, for example). Alternatively, digital content distribution criteria 302 may be received in other ways, such as by being pre-programmed into source communication device 102 or sink communication device 112, or received via LAN 120 or WAN 125. In another alternative, digital content distribution criteria 302 may come from a third party (for example, a local or remote service) rather than directly from the participants in the distribution transaction.

Examples of digital content distribution criteria 302 include but are not limited to information regarding: a user's identity (claims that the user is asserting about who he is), a user's various favorites or preferences (for example, a user's ratings of music, a user's listening patterns, or a user's purchasing patterns); user profiles (for example, personal information such as name, address, gender, and age); service profiles (whether a user has opted-in to participation peer-to-peer distribution transactions, for example, and opt-in conditions, if any); user affiliations (such as buddy lists); device-gathered location information; and digital rights management information associated with digital content information items 103 (such as whether a user has the right to distribute a particular digital content item pursuant to an applicable digital license 160, or any restrictions on such rights). Digital content distribution criteria 302 may also include expressions involving logical references to other digital content distribution criteria 302 or to digital content items 103. Boolean operands such as “AND,” “OR,” and “NOT”, along with other operands or types thereof, may be used to define such expressions. It will be appreciated that virtually unlimited digital content criteria 302 and combinations thereof are definable.

As shown in FIG. 3, source communication device 102 uses digital content distribution criteria 302 for decision-making regarding digital content identification 304. Digital content identification 304 represents acts associated with identifying subset 105 of digital content items 103 that is available for distribution by source communication device 102 using P2P Content Distribution System 101. It may be desirable to represent and/or store digital content items 103 within subset 105 in a dedicated area of digital content information repository 208 within source communication device 102.

In one scenario, digital content identification 304 involves source entity 104 manually selecting one or more digital content items 103 for inclusion in subset 105 via user interface 102. In another scenario, digital content identification 304 involves source communication device 102 automatically selecting one or more digital content items 103 for inclusion in subset 105. With respect to automatic selection, source communication device 102 may evaluate expressions of digital content criteria 302 designed to identify items within subset 105. For example, the last audio file without DRM restrictions received from another source communication device in a particular WiFi hotspot may be automatically selected for inclusion in subset 105. In another example, a list of recently played music may be selected for inclusion in subset 105.

Referring again to the flowchart of FIG. 3, source communication device 102 proceeds to publish digital content availability message 305 to other nodes associated with a particular network (for example, WLAN 116), including sink communication device 112. It is assumed that source communication device 102 and sink communication device 112 have both entered the same communication region (such as a local communication region or a virtual location within a WAN) and have acquired IP addresses or possess other endpoint identifiers. It will be appreciated, however, that IP-based services are not required to implement aspects of the distribution transactions discussed herein. Digital content availability message 305 is any signal transmitted using any suitable protocol by or on behalf of source communication device 102 for the purpose of notifying other nodes within a communication network of the availability of digital content for distribution via P2P Content Distribution System 101.

Digital content availability message 305 may be a message transmitted a number of times by source communication device 102 that contains a few specifics about source communication device 102 (such as the model name and number, serial number, or manufacturer name, identity claims requested by source entity 104) and/or services implemented by device discovery engine 212 or digital content distribution engine 214 (for each service, the description may include a list of commands/actions the service responds to, and parameters/arguments for each command/action), and a pointer to more detailed information. The message content may be defined using properties encoded using an extensible markup language (“XML”) schema or another technique. XML properties generally have names specified using strings, have assumed types, and assume simple fixed values.

Referring again to FIG. 3, sink communication device 112 detects digital content availability message 305 and transmits sink identification message 307. Sink identification message 307 is any signal transmitted, using any suitable protocol, by or on behalf of sink communication device 112 for the purpose of identifying the availability of the sink communication device for distribution transactions via P2P Content Distribution System 101.

In general, sink communication device 112 may be configured to automatically search a predefined address for discovery messages sent by potential participants in digital content distribution transactions and to use the information in the discovery message to send a sink identification message 307 to source communication device 102. Alternatively, sink communication device 112 may be configured to notify sink entity 114 prior to searching for discovery messages or sending sink identification message 307. If communication device 112 is configured to notify sink entity 114, then some form of user interface is generally provided via user interface 102.

The service implemented by discovery engine 212 is generally configured to respond to requests for information from sink communication device 112 regarding the properties of the service. For example, the service is generally able to respond correctly for properties it recognizes, and provide at least a “property not found” result if the property is not available. One example of a defined property of the service implemented by device discovery engine 212 is a property that provides information about the IP address and port for a service (such as a service implemented by Digital Content Distribution Engine 214) responsible for enumeration and distribution of digital content items 103 within subset 105.

In some cases anonymous access may be supported via a general system of hand-shaking/negotiation, and it may also be desirable to implement various scenarios involving levels of anonymity, such as “directed identity” cases where one party (for example the source entity) obtains information about the identity of the other party, but the other party does not receive such identity information. In an exemplary limitation, however, sink communication device 11.2 (for example, via access management engine 213) facilitates presentation of a particular digital identity associated with sink entity 114 or sink communication device 112 to source communication device 102 via sink identification message 307. For example, a user interface may be provided to sink entity 114, and sink entity 114 may be prompted to select a digital identity from among a number of possible identities presentable to source communication device 102. Alternatively, sink communication device 112 may automatically select from among a number of possible digital identities presentable to source communication device 102. One or more claims, which may be self-issued and/or verifiable via source communication device 112 or a third-party verification service, are generally made regarding items of information associated with each presentable identity (together items of information and claims are referred to as “credentials”). Examples of credentials associated with identities include but are not limited to SIM card information, email information, payment instrument information, phone number information, affiliation information, and name information.

Referring again to FIG. 3, based on digital content availability message 305 and/or sink identification message 307, a proximity determination 308 is performed by source communication device 102, sink communication device 112, or both. Proximity determination 308 represents one or more automatic or manual acts or criteria for determining whether source communication device 102 and sink communication device 112 are available for the purpose of distributing digital content items 103 selected from subset 105 using P2P Content Distribution System 101. Proximity may be determined on a periodic basis. Although the exemplary distribution transaction involves source communication device 102 operated by source entity 104 and sink communication device 112 operated by sink entity 114, it will be appreciated that proximity determination 308 may involve automatic or manuals acts or criteria for determining whether other communication devices are available for distribution transactions, and that proximity determination 308 may result in identification of a subset of proximate devices and/or entities.

One circumstance under which source communication device 102 and sink communication device 112 may be deemed to be in proximity is when source communication device 102 and sink communication device 112 are within a certain physical distance from each other. In one example, the boundaries of a local communication region may provide the limits of the physical distance—whenever both source communication device 102 and sink communication device 112 are both within the same local communication region, proximity is deemed to exist. In another example, proximity may be deemed to exist when both source communication device 102 and sink communication device 112 are within static or dynamic physically definable sub-regions of a local communication region. Examples of static physically definable sub-regions of a local communication region include particular geographical regions such as departments of retail locations (music sales departments, for example), streets, groups of offices, or buildings. An example of a dynamic physically definable sub-region of local communication region includes a predetermined maximal distance between source communication device 102 and sink communication device 112. Various commercially available systems and/or products may be used for location determination. Such systems and/or products are generally based on technologies such as global positioning system (“GPS”) technology, triangulation technology, signal strength analysis technology, or time-distance-of-arrival technology.

Other circumstances under which source communication device 102 and sink communication device 112 may be deemed to be in proximity are defined by one or more virtual or logical relationships between source entity 104 and sink entity 114. Such virtual or logical relationships may be used alone, or as filters in conjunction with certain physical distances, to determine when source communication device 102 and sink communication device 112 are in proximity. For example, source and sink entities within a local communication region or sub-regions thereof that have predetermined zip codes, genders, ages, places of employment, preferences (such as music preferences), friends, or other logically-relatable characteristics may be deemed to be in proximity. In another example, virtual relationships may be defined (using, for example, contacts within an email program, buddy lists within an instant messaging program, participants in an online forum hosted on a website, and the like) or discovered, and the virtual relationships used to determine proximity in a logical manner. A logical or virtual proximate relationship may co-exist with, or exist independent of, other, pre-established affiliations. It will be accordingly appreciated that proximity may be defined as broadly or narrowly as desired, encompassing everyone/every device or only select entities or devices, and such proximity may exist between entities in the same immediate area, halfway around the world, or any distance in between.

It will be appreciated that certain digital content distribution criteria 302 could be evaluated and/or exchanged (for example, separately, along with, or referenced within, digital content availability message 305 or sink identification message 307) and evaluated by sink communication device 112 or source communication device 102 to determine physical or virtual proximity between source entity 104 and sink entity 114.

Referring again to FIG. 3, assuming proximity is deemed to exist, an availability determination 309 is optionally performed by source communication device 102. Availability determination 309 represents one or more automatic or manual acts or criteria for determining whether, and the extent to which, source communication device 102 is available for the purpose of distributing digital content items 103 selected from subset 105 using P2P Content Distribution System 101. In one exemplary implementation, source communication device 102 may use the identity presented via sink communication device 112 to provide granular control over what system services are available to sink communication device 112/sink entity 114. For example, if sink communication device 112 presents an identity including credit card number information via sink identification message 307, sink entity 114 may be granted access to more services supported by source communication device 102 than if sink communication device 112 presents an identity including only phone number information via sink identification message 307 or requests anonymous access.

Referring again to the message sequence chart of FIG. 3, communication session establishment 310 occurs. Communication session establishment 310 involves establishing P2P communication session 152 between source communication device 102 and sink communication device 104. It should be noted that communication session establishment 310 may be deemed to have occurred whenever devices are able to discover each other. For example, communication session establishment 310 may be deemed to have occurred when source communication device 102 and sink communication device 112 communicated via digital content availability message 305 and sink identification message 307. In general, however, communication establishment 310 involves additional steps (which may be performed by access management engine 213) relating to establishing a level of trust between source communication device 102 and sink communication device 112.

One aspect of establishing a level of trust involves the performance of authentication and authorization activities (by source communication device 112 or a network service provider) with respect to the identity/credentials presented by sink communication device 112 via sink identification message 307. Authentication is the process of identifying a user. Authorization is the process of enforcing policies relating to what types of qualities of activities, resources, or services the user is permitted to access. Authentication may also encompass the authorization process. Any desirable now known or later developed authentication and authorization scheme or technology may be used to establish a level of trust and/or to verify the identity/claims presented by sink communication device 112. Examples of authentication and authorization schemes include but are not limited to user name and password schemes, Kerberos technologies, Microsoft® CardSpace™ technologies, proprietary authentication mechanisms, and other known or later developed implementations.

Once P2P communication session 152 has been established, sink communication device 112 and source communication device 102 commence communication about a specific digital content distribution transaction. As shown in FIG. 3, sink communication device 112 sends digital content identification request message 311 to source communication device 102. Digital content identification request message 311 is any signal transmitted, using any suitable protocol, by or on behalf of sink communication device 112 for the purpose of requesting participation in a distribution transaction via P2P Content Distribution System 101. Digital content identification request message 311 may be sent to a service operating within source communication device 102, such as digital content distribution engine 214. In operation, digital content identification request message 311 may be a command issued by sink communication device 112 to the URL or service for digital content distribution engine 214 previously obtained from source communication device 102.

In one implementation, digital content identification request message 311 includes a request for an identification of each digital content item 103 within subset 105, or a request for access to certain services available via source communication device 102. In an alternative implementation, digital content identification request message 311 includes a request to use certain digital content criteria 302 to automatically identify one or more digital content items 103 within subset 105 for distribution without direct input from sink entity 114. Digital content criteria 302 may be communicated to source communication device 102 using a message such as digital content identification request message 311 or a subsequent message in various ways—digital content criteria 302 may be attached to a message, or the message may include a pointer to digital content criteria 302, for example.

With reference to the exemplary distribution transaction between George and David, who are both near the same WiFi hotspot in a coffee shop, David may be operating the feature on his media player (sink communication device 112) that implements P2P Content Distribution System 101 in “manual” mode or in “automatic” mode. In manual mode, David would be alerted that his media player has detected George, and David would be prompted to indicate whether he would like to investigate digital content available for distribution by George. For example, a reference to George (such as an avatar or screen name or the like) may appear on David's user interface, and David may select George via the user interface. David may also be prompted to select a digital identity from among a number of digital identities to be presented to George's media player. Each digital identity may be used to present different credentials (or sets of credentials) to George's media player for verification. Examples of such credentials include but are not limited to David's name, phone number, billing account information, email address, and the like. David's selection of George and a digital identity via the user interface results in sink identification message 307 being transmitted to George's media player. Once David's identity has been verified by George's media player or a network service, David is presented with various service options (such as “browse digital content library”, “browse playlists”, “send photo”, “send song”, and the like) accessible via George's media player, depending on the digital identity presented. The various service options may be presented via a mechanism such as an HTML-style web page, an XML-based presentation model, or any other suitable mechanism or technique that allows a user to browse particular contents. David's selection of a particular service option results in digital content identification request message 311 being transmitted to George's media player.

In automatic mode, David may or may not be alerted that his media player has detected George. Digital content available for distribution by George would be investigated, and a particular identity associated with David or David's media presented, without further input from David, based on pre-determined digital content distribution criteria 302 on David's media player (for example, David's media player would automatically transmit sink identification message 307 and digital content identification request message 311/digital content distribution criteria 302 to George's media player). It should be noted that even when David begins the distribution transaction in manual mode, he may choose to complete the transaction or portions thereof in automatic mode—that is, David may choose a particular identity, or choose to request an identification of each digital content item George has available for distribution, or he may choose to allow certain digital content items to be automatically identified and/or distributed based on digital content distribution criteria 302.

Referring again to FIG. 3, in response to digital content identification request message 311, source communication device 102 transmits digital content identification message 313 to sink communication device 112. Digital content identification message 313 is any signal transmitted, using any suitable protocol, by or on behalf of source communication device 102 for the purpose of communicating information about the content of subset 105 of digital content information items 103 to sink communication device 112 and/or sink entity 114 (it is assumed that sink identification message 307 contained credentials sufficient to allow access to digital content of source communication device 102).

In the scenario where content identification request message 311 includes a request for an identification of certain digital content items 103 within subset 105, or access to a specific service offered via source communication device 102, digital content identification message 313 may include a pointer to the contents of a location (such as a virtual folder or a catalog) within data repository 208 in (or accessible via) source communication device 102 that includes information about digital content item(s) within subset 105 (and optionally the item(s) themselves). The contents of the location may be arranged or referenced in a manner that enables source entity 114 to view and evaluate the content via a user interface. Examples of suitable content arrangements include tables, lists (such as a playlist), or catalogs. To view the content, sink communication device 112 may issue a request to digital content distribution engine 214 on source communication device 102 for the location provided in digital content identification message 313. It will be appreciated that the method of access to content distribution engine 214 may have been provided in a previously transmitted message. In this case, digital content identification message 313 may not be necessary.

In the scenario where content identification request message 311 includes a request to use certain digital content criteria 302 to automatically select one or more digital content items 103 within subset 105 for distribution without direct input from sink entity 114, digital content identification message 313 may identify certain digital content items 103 within subset 105 that meet digital content criteria 302 (for example, based on the best match of digital content criteria 302 received via digital content identification request message 311). For example, digital content identification message 313 may include a pointer to the contents of a location within data repository 208 in (or accessible via) source communication device 102 that includes information about objects within subset 105 (and optionally the objects themselves) that meet digital content criteria 302. Alternatively, digital content identification message 313 may include other information pertinent to automatically identifying one or more digital content items 103 within subset 105, such as additional digital content distribution criteria 302 associated with source communication device 102, or information about possible matches to digital distribution criteria 302 of the sink communication device. Such other information may be used in a further negotiation between source communication device 102 and sink communication device 112, which is designed to automatically identify certain digital content items within subset 105.

Next, sink communication device 112 uses digital content distribution criteria 302 for decision-making regarding digital content identification 312. Digital content identification 312 represents acts (performed by sink communication device 112 and/or sink entity 114) associated with selecting specific digital content items 103 within subset 105 from among those communicated, via digital content identification message 313, as being available for distribution from source communication device 102. Digital content identification 312 can be implemented in at least two ways—with real-time input from sink entity 114, or automatically, without real-time input from sink entity 114.

In the scenario where digital content identification 312 is implemented with real-time input from sink entity 114, sink entity 114 generally inputs digital content selection criteria 316 via a user interface, which displays the contents of subset 105 (for example, the contents of the location within source communication device 102, accessed via a request to the digital content distribution engine 214 on source communication device 102 for the location provided in digital content identification message 313 or another message). Sink communication device 112 identifies the digital content item to be requested based,digital content selection criteria 316.

With reference to the exemplary distribution transaction between George and David, if David is operating his media player in manual mode, references to digital content available for distribution by George via the available digital content/services selected by David may appear on David's user interface, in the vicinity of the reference to the selected digital content/services. David's subsequent selection of one or more digital content items serves as digital content selection criteria 316 that results in his media player identifying the digital content item to be requested.

In the scenario where digital content identification 312 is implemented automatically, if digital content identification message 313 includes a final identification of one or more digital content items from subset 105 to be distributed, further digital content identification 312 may not be necessary. Alternatively, if further digital content identification 312 is necessary, sink communication device 112 may select one or more digital content items within subset 105 to be requested based on the evaluation (for example, a determination of the best match) of digital content distribution criteria 302 (or other information) received from source communication device 102 via digital content identification message 313. For example, digital content identification 312 may involve evaluating criteria or expressions designed to filter received content by type (such as music files, further filtered by criteria such as artist, title, genre, and the like); general favorites or preferences; ratings or parental control settings; file size; source entity (for example, only receive content from friends of friends); or communication device-related parameters (such as battery power or available memory). It will be appreciated that other criteria or expressions are also possible.

With reference to the exemplary distribution transaction between George and David, if David is operating his media player in automatic mode, then references to digital content available for distribution by George may or may not appear on David's user interface. Further negotiation between David's and George's media players may be necessary to select digital content items for distribution, but such negotiations are conducted without further input from David.

Referring again to FIG. 3, digital content request message 318 is any signal transmitted, using any suitable protocol, by or on behalf of sink communication device 112 for the purpose of requesting distribution of one or more specific digital content items 103 within subset 105. Source communication device 102 receives digital content request message 318, and based on the message, distributes the specific digital content item(s) 103 or identifier(s) used for obtaining the specific digital content item(s) (if such information has not previously been provided). Digital content request message 318 includes either a request for a one-time distribution of digital content item(s) 103 or a request for a subscription to updates of digital content item(s) 103, or both.

If requested digital content item(s) are protected by one or more intellectual property rights, then it is arranged for one or more digital licenses 160 to be distributed to sink communication device 112 either before distribution of the requested digital content item(s) to sink communication device 112 (license pre-delivery, indicated at license acquisition step 320) or after distribution of the requested digital content item(s) to sink communication device 112 (license post-delivery, indicated at license acquisition step 322). In the case of license pre-delivery, identifiers, such as headers of content files, are returned to sink communication device 112 in response to digital content request message 318 (and additional digital content request message/digital content transfer steps may need to be performed to complete distribution of the actual digital content items(s)). In the case of license post-delivery, content file headers associated with the transmitted digital content item(s) 103 indicate where digital license(s) 160 may be obtained. In an alternative implementation, a limited digital license to use, reproduce and/or distribute digital content items protected by one or more intellectual property rights may be provided with the protected content itself. For example, the limited digital license may allow a single use or distribution of the protected content. In general, a content file header has several parts relevant to obtaining a digital license: a security identifier (such as a key identifier); a digital license acquisition URL; an indicator of whether the digital license is delivered before or after the digital content it protects; and a content file type or format.

With continuing reference, to FIGS. 1-3, FIG. 4 is a message sequence chart illustrating steps associated with distributing digital licenses 160 from a license distribution server/service associated with digital license distribution system/service 161 available via LANs 120 and/or WANs 125 or a source communication device 102 hosted server/service to a client-side communication device, such as a communication device (direct license distribution) or to an intermediate device such as a PC to which the communication device is connectable (indirect license distribution) via a non-network capable connection. The digital license distribution server/service may provide network services to the source entity and/or the sink entity, or may be an independent third party. It will be appreciated however, that peer-to-peer distribution of digital licenses 160 is also possible with source communication device 102 performing functions of digital license distribution system/service 161 including generation of full or limited licenses to digital content.

The simplest form of direct license acquisition involves the use of a header identifying the location from which a digital license for the content may be received. In this scenario, the client-side communication device is assumed to be sink communication device 112, and the network-side server/service is assumed to be digital license distribution system/service 161. The steps illustrated in FIG. 4 are applicable to both license pre-delivery and license post-delivery scenarios—it is assumed that sink communication device 112 has received a content file header associated with the digital content item(s) 103 that identifies and provides a URL for digital license distribution system/service 161. Exemplary embodiments of license acquisition schemes use simple protocols like HTTP to exchange messages between sink communication device 112 and digital license distribution system/server 161. To enable richer communication between these entitles, the header for digital content item(s) 103 may specify the use of richer protocols, such as those based on Web Services technologies. The use of richer protocols enables a better establishment of trust between sink communication device 112 and digital license distribution system/server 161, the ability to communicate additional information about the device, or other pieces of information deemed necessary to improve the distribution of digital licenses. The content file header may also contain additional items to support the authentication/authorization of sink communication device 112 to distribution server/service 161. Examples of authentication/authorization information include the type or method of authentication/authorization to be used for the license transaction and identity claims, or information on where to retrieve such claims, provided by distribution system/service 161. Other forms of authentication/authorization information consistent with the model described herein may also be used. As used herein, the term “distribution” and forms thereof includes both acts associated with transferring digital licenses 160 and acts associated with receiving digital licenses 160.

Initially, sink communication device 112 transmits a license challenge message 402 to digital license distribution system/service 161. License challenge message 402 is any signal transmitted, using any suitable protocol, by or on behalf of a communication device for the purpose of requesting a digital license (or a renewal of a time-limited digital license) for a particular digital content item 103. Generally, DRM engine 220 (optionally with the use of helper applications) within sink communication device 112 arranges for sending license challenge message 402 to the license acquisition URL found within the header file associated with a particular digital content item 103. Sink communication device 112 may display a message, via user interface 102, to let sink entity 114 know that the digital license is being acquired. Upon receipt of license challenge message 402, certain security-related authentication and authorization activities may be performed to establish a level of trust between sink communication device 112 and digital license distribution system/service 161. One example of authentication/authorization activities is the use of secure, revocable keys, issued to equipment manufacturers and/or individual devices and authorized for use with distribution server/service 161. In this model sink communication device 112 is generally considered to support device-based authentication. This implies that the license is issued or bound to the device, which holds the specified keys. Since users may have more than one device, or one device may be used by more than one user, this requires additional work for distribution server/service 161 to track and manage devices associated with a particular user. In general these tracking schemes are implemented in a proprietary fashion by different creators and maintainers of digital license distribution system(s)/service(s) 161. The end result is that distribution of P2P content received from one instance of license distribution system/service 161 may not be possible to a user who is using a different instance of license distribution system/service 161.

Manufacturers of communication devices wish to enable users of these devices to retrieve content from one or more distribution servers/services irrespective of the secure, revocable keys issued to equipment manufactures and/or individual devices. In this case a method of authentication must be established which enables distribution server/service 161 to perform authentication/authorization activities with the recipient of the license, sink communication device 112 in this example, which involves the exchange of more universally recognized identities. Generally, information for this additional level of authentication/authorization will be transmitted along with license challenge message 402. The additional information provided may conform to a publically defined standard or to a proprietary standard defined by license distribution servers/services 161. Publicly defined standards, may be general in nature or be domain specific. Examples of publicly defined standards may include, but are not limited to, SIM identifiers used by cellular phone carriers to identify individual customers or a security token retrieved from a Microsoft® Windows® operating system that supports CardSpace™ identity technology. In each of these cases the presentation of this information may also be an indication to the service that the user of sink communication device 112 has authorized digital license distribution system/server to use any consideration claims associated with these counts for billing or other consideration purposes. Alternate/authorization/authentication schemes may use methods such as Internet browser cookies to store distribution server/service 161 proprietary information, which will be transmitted along with license challenge message 402. Sink communication device 112 may require information be provided in the content header to determine the correct type or method of authentication to supply when sending license challenge message. 402. It will be appreciated that other known and later developed forms of authentication/authorization schemes may be applied between distribution server/service 161 and sink communication device 112 to establish a level of trust.

Next, digital license distribution system/service 161 creates a license response message 404, which is transmitted back to sink communication device 112. License response message 404 is any signal transmitted, using any suitable protocol, by or on behalf of a digital license distribution system/service for the purpose of providing a digital license for a particular digital content item 103. The digital license grants rights to source entity under certain intellectual property rights, but may also include restrictions on such granted rights in accordance with certain business rules. For example, the digital license may expire after a period of time (such as a month, a week, or a day). Digital license response message 404 may also include a reference to a location (such as a URL included in the header of license response message 404) to which metering information regarding the digital license may be transmitted by sink communication device 112. Under some circumstances license response message 404 may not contain a digital license (for example in the event that a license is not available or authentication/authorization was not possible). It may also contain a URL to another network-side service with which sink portable communication device 112 must interact before the license may be retrieved. In the simplest case the URL may be to a web site with which the user of sink communication device 112 must interact before the license may be issued. Alternate methods of delivery exist for license response message 404 to enable digital license distribution server/system 161 to deliver a license response message 404 which contains a digital license. In addition other methods of redirection exist now or may exist in the future, which are consistent with the principles and procedures defined herein.

Generally, when a digital license is attached to a license response message 404, a complete digital license is present, although in some implementations keys or other security devices may be provided to activate pre-existing digital licenses stored on sink communication device 112. Other license scenarios are also possible. In one exemplary implementation, a “root” license, which represents the basic rights to content of a particular service provider (such as a video-on-demand provider, a music provider, or a network-based peer-to-peer file sharing service), may be provided to sink communication device 112. Then, rights to specific content, pursuant to the terms of the root license, may be conferred by “leaf” licenses as the specific content is obtained.

Upon receiving license response message 404, license-storing steps 406 are performed at sink communication device 112. Sink communication device 112 may display a message, via user interface 102, to let sink entity 114 know that the digital license is being stored (although if the digital license was not successfully obtained, the message may indicate that license acquisition failed). In one implementation, license storing steps 406 include processing the license response message 404 to retrieve a unique identifier associated with the digital license (such as a transaction identifier (“TID”) that may be a randomly generated, 16-byte identifier base-64-encoded to form a 24 character string or another identifier), storing the digital license in a computer-readable memory; and generating a license status (such as a confirmation that the digital license was stored in the computer-readable memory). Sink communication device 112 may display a message, via user interface 102, to let sink entity 114 know whether storage of the digital license was successful or unsuccessful. Sink entity may also be prompted to accept the terms of the digital license, and if the terms are not accepted, the license would not be stored and additional access/rights to the applicable digital content item(s) would not be granted.

Next, sink communication device 112 optionally creates a license status message 408, which is transmitted back to digital license distribution system/service 161. If digital license response message 404 included a reference to a location to which metering information regarding the digital license is transmittable, license status message 408 may be transmitted to that location. Otherwise, license status message 408 may be transmitted to the license acquisition URL. License status message 408 is any signal transmitted, using any suitable protocol, by or on behalf of a communication device, for the purpose of confirming receipt of a digital license. In one implementation, the unique identifier associated with the digital license (such as the TID), which was obtained via license response message 404, is included with license status message 408. Digital license distribution system/service 161 may implement a timeout service, so that if license status message 408 is not received within a predetermined timeframe, or if the license was not stored (because of an equipment failure or because the terms of the license were not accepted, for example) delivery of the digital license is deemed a failure. In the license pre-delivery case, digital license distribution system/service may transmit a content URL to sink communication device 112, indicating the location from which the digital content item(s) covered by the digital license may be obtained.

Sink communication device 112 may also optionally send additional messages (subject to appropriate privacy concerns and protections) to report metering information regarding the exercise of sink entity's rights pursuant to the digital license. Such metering information may be collected and processed by digital license distribution system/service 161 or a third party.

While receipt of a digital content header which contains digital license request information is the simplest method to initiate a direct license acquisition as described, alternate methods for distribution of digital content and associated licenses using digital content distribution system/service 101 are possible. In one scenario, source communication device 102 informs sink communication device 112 that digital content item 103 is available using digital content identification message 313 and that it requires a digital license in order to be used. Based on the information provided by source communication device 102, sink communication device 112 may use one or more services of digital content distribution system/service 161 with which it is affiliated to determine if the digital content and license may be directly retrievable by sink device 112 instead of receiving it from source device 102. For example, source device 102 may provide sink device 112 with enough detailed information about a particular music track on a particular album by a particular artist that sink device 112 is able to ask the music service with which it is affiliated whether or not the track is available. If available, sink device 112 may retrieve the content directly from the service rather than via source communication device 102. Alternatively, source device 112 may provide sink device 102 with a globally unique identifier that may be resolvable to the content by the service. Another scenario of the digital license messaging flow described herein may define one or more well known protocols for sending and receiving messages between digital license distribution server/system 161 and sink communication device 112. When intermediate network elements between digital license server 161 and sink communication device 112 detect the use of the protocol(s) it may step in and perform additional work on behalf of sink communication device 112, for example providing authentication/authorization information or consideration information, to complete the license distribution process. Another scenario of the license distribution process may enable source communication device 102 to issue a license directly to sink communication device 112 by acting in behalf of licensed distribution server/system 161. In one example source communication device 102 is enabled to issue a license with restricted permissions, such as a limited number of uses or a specific expiration period, to sink communication device 112. Under other circumstances sink communication device 102 may be authorized to stand as proxy for license distribution system/service 161 and issue a full license. The authority for source communication device 102 to issue licenses for digital content item(s) 103 may be included as a permission granted with receipt of the license for the digital content or it may be delivered through some other mechanism.

Before returning to the description of the message sequence chart of FIG. 3, the distribution of digital content item(s) 103 is more fully discussed. To accomplish one-time distribution of digital content item(s) 103, digital content request message 318 may be a copy command, an MTP GetObject command, or the like on the location specified for the digital content item(s) via digital content identification message 313. If digital content identification message 313 did not contain the location for digital content item(s) 103, digital content request message 318 may request the addresses, and source communication device 102 and/or sink communication device 112 may then initiate the command. It will be appreciated that other file transfer protocols or techniques are also possible.

To accomplish a subscription to updates of digital content item(s), a service to handle such subscriptions (such as a service implemented by digital content distribution engine 214) may be provided. One approach for handling subscriptions is to establish (or contract with a third party for) a web service, accessible via WAN 125 (for example, the Internet), to which source communication device 102 may write, and from which sink communication device 112 may read. The web service is then available as an intermediary for updates of content when source communication device 102 and sink communication device 112 are not in proximity. In one implementation, digital content distribution engine 214 can be configured to be an RSS-aware system, so that RSS feeds would be available whenever access to WAN 125 is available. Alternatively, digital content distribution engine 214 may support asynchronous messaging paradigms such as “pub/sub”. Other distribution-related features are also possible. For example, portions of digital content item(s), such as content slices, may be distributed as they become available (using the pub/sub model, for example). In another example, if distribution of digital content item(s) is interrupted for some reason (such as if a participant in the distribution transaction travels out of range of P2P communication session 152, or because of interference or other data distribution loss), the distribution transaction may automatically resume when the participants next becomes proximate. Alternatively, another distribution transaction for the same digital content item(s) may automatically be established whenever the digital content items(s) are available from another source. It will be appreciated that a wide variety of features, functions, and user experiences may be created using aspects of the digital content distribution systems and techniques described herein.

Referring again to FIG. 3, digital content distribution records 324, which summarize pertinent information about digital content and digital license distribution transactions (such as parties/identities, devices, and service providers involved, identifying information associated with the digital content item(s), digital license distribution information (for example, transaction identifiers), where the transactions occurred, consideration transfers, and the like), are created and managed. Digital content distribution records 324 may be used by source entity 102, sink entity 114, or network service providers to track operation of P2P Content Distribution System 101 or digital license distribution system/service 161.

Digital content distribution records 324 (specifically information such as unique transaction identifiers) may also be used in connection with consideration management activities (handled by consideration management engine 224), to trigger consideration transfer(s) 328. Consideration transfers are transfers of things having value, such as promises to pay money, promises to perform services, and redeemable articles. In one example, when sink communication device 112 transmits license status message 408, a network-side billing event may be triggered (billing may be performed by a provider of services to the source entity, the sink entity or a third party), and sink entity may provide, or promise to provide, payment in response to the billing event. Payment may be provided via sink communication device 112 or in another manner. In another example, transmission of license status message 408 by sink communication device 112 may trigger a transfer of consideration (such as a monetary or other reward, such as the receipt of a redeemable article) to source entity 104 via source communication device 112. It will be appreciated that any suitable now known or later developed file transfer protocols or techniques may be used to accomplish consideration transfers, and that third-party service providers may handle aspects of consideration transfer. Various entities (such as content owners, distributing users, retailers that distribute content or licenses to users, network service providers, or advertising services) are optionally participants in a chain of consideration. For example, assume that a first participant in a P2P distribution transaction is a member of a first content service, a second participant in the P2P distribution transaction is a member of a second content service, and the first participant distributed a content item to the second participant. The second participant could obtain a content license from the first content service, the first content service could notify the second content service of the successful receipt of the license by the second participant, and the second content service could transfer consideration to the first content service, and the second content service could bill the second participant. In this manner, flexible e-commerce models that encourage legal, peer-to-peer distribution of digital content are supported.

With reference to the exemplary distribution transaction between George and David, David interacts with his media player, and notices that digital content distributed from George appears within a folder configured to store information received via P2P distribution transactions. David also notices that the digital content is tagged as being received at the coffee shop from George. In the license pre-delivery scenario, David notices that the actual content file is not present on his media player, but a content header file (or a link thereto) indicating where a digital license (and the content itself) may be obtained is present on his media player. David is prompted to indicate whether he would like to start rendering the content file once enough of the content file is downloaded (after license acquisition) to render the file without interruption. In the license post-delivery scenario, David notices that a content file is present. David attempts to render the content file, and receives a message that he is required to obtain a license before rendering the file. In both the license pre-delivery scenario and the license post-delivery scenario, once David decides to obtain the digital license required to render the content file, David can either use his media player to obtain the digital license directly (assuming an Internet connection is available), or, if the service supports it, connect his media player to his home PC, and obtain the digital license indirectly using the Internet connection for the PC. Once David successfully obtains the digital license, David's media player (or PC) automatically sends a license status message to a network-based metering service, and some time later, a charge for the digital license appears on one of David's accounts that he designated for billing purposes in connection with P2P distribution transactions (such as his mobile phone bill, credit card statement, or bank statement).

George also interacts with his media player, and notices that someone (David may or may not have revealed his identity) in the coffee shop downloaded some of the digital content (or headers thereof) George made available for distribution via P2P distribution transactions. Some time later, after David has successfully obtained a digital license associated with the digital content, George notices that he has received redeemable reward points from the music service from which he originally obtained the digital content as a reward for distributing content via a P2P communication system.

The digital content distribution systems and techniques described herein enable a wide variety of digital content to be discovered and distributed by communication devices in a peer-to-peer manner. The intellectual property rights of third parties in the digital content are protected, distribution costs are reduced, and flexible e-commerce models that encourage distribution of digital content are supported. As more entities participate in P2P digital content distribution transactions, the opportunities to discover and distribute fresh digital content can become virtually ubiquitous—distribution transactions may occur potentially wherever participating communication devices co-exist in the physical or virtual world. Communication devices may function as both sources and sinks in the same transaction, thus increasing opportunities for cross-pollination of digital content. A sink communication device that receives particular digital content may later become a source communication device that supplies the same digital content, providing an interesting business model for digital content distribution.

From a user perspective, a diverse network is developed and the chore of discovering digital content is reduced in a secure, legal, unobtrusive manner. Digital content may be obtained wherever individuals having common traits or interest gather together, thus increasing the social impacts of such gatherings. Users are presented with abundant, flexible, options for customization and control of discovery and distribution options. For example, users are able to manage digital identities presented to potential participants in distribution transactions, and to limit (or expand) participants with whom, and venues within which, distribution transactions can occur.

With continued reference to FIGS. 1-4, FIG. 5 is a block diagram of an exemplary configuration of an operating environment (such as source communication device 102, sink communication device 112, or a network-side server/service) in which all or part of P2P Content Distribution System 101, and/or the methods shown and discussed in connection with FIGS. 3 and 4, may be implemented or used. Operating environment 500 is generally indicative of a wide variety of general-purpose or special-purpose computing environments, and is not intended to suggest any limitation as to the scope of use or functionality of the system(s) and methods described herein. For example, operating environment 500 may be a type of portable (including in-vehicle devices) or non-portable device such as a digital media player, a server, a personal computer (“PC”), a personal digital assistant, or a mobile phone, among other things.

As shown, operating environment includes processor 502, computer-readable media 504, and computer-executable instructions 506. One or more internal buses 521, which are widely available elements, may be used to carry data, addresses, control signals and other information within, to, or from operating environment 500 or elements thereof.

Processor 502, which may be a real or a virtual processor, controls functions of operating environment 500 by executing computer-executable instructions 506. Processor 502 may execute instructions 506 at the assembly, compiled, or machine-level to perform a particular process.

Computer-readable media 504 represent any number and combination of local or remote devices, in any form, now known or later developed, capable of recording, storing, or transmitting computer-readable data, such as computer-executable instructions 506, digital content items 103, digital content distribution criteria 302, digital content distribution information/records 324, digital license distribution information 207, or data storage elements such as virtual folders. In particular, computer-readable media 504 may be, or may include, a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a,bubble memory; a cache memory; a core memory; a holographic memory; a memory stick; a paper tape; a punch card; or any combination thereof. Computer-readable media 504 may also include transmission media and data associated therewith. Examples of transmission media/data include, but are not limited to, data embodied in any form of wireline or wireless transmission, such as packetized or non-packetized data carried by a modulated carrier signal.

Computer-executable instructions 506 represent any signal processing methods or stored instructions. Generally, computer-executable instructions 506 are implemented as software components according to well-known practices for component-based software development, and encoded in computer-readable media (such as computer-readable media 504). Computer programs may be combined or distributed in various ways. Computer-executable instructions 506, however, are not limited to implementation by any specific embodiments of computer programs, and in other instances may be implemented by, or executed in, hardware, software, firmware, or any combination thereof.

As shown, certain computer-executable instructions 506 implement user interface functions 503, which implement aspects of user interface 202 (shown in FIG. 2); certain computer-executable instructions 506 implement network interface functions 510, which implement aspects of network interface(s) 210; certain computer-executable instructions 506 implement device discovery functions 512, which implement aspects of device discovery engine 212; certain computer-executable instructions 506 implement digital content distribution functions 514, which implement aspects of digital content distribution engine 214, certain computer-executable instructions 506 implement access management functions 513, which implement aspects of access management engine 213, certain computer-executable instructions 506 implement DRM functions 520, which implement aspects of DRM engine 220, certain computer-executable instructions 506 implement activity metering functions 522, which implement aspects of activity metering engine 222, and certain computer-executable instructions 506 implement consideration management functions 524, which implement aspects of consideration management engine 224.

Input interface(s) 516 are physical or logical elements that facilitate receipt of input to operating environment 500. Input may be received using any type of now known or later-developed physical or logical elements, such as user interfaces, remote controls, displays, mice, pens, styluses, trackballs, keyboards, microphones, scanning devices, and all types of devices that are used input data.

Output interface(s) 518 are physical or logical elements that facilitate provisioning of output from operating environment 500. Output may be provided using any type of now known or later-developed physical or logical elements, such as user interfaces, displays, printers, speakers, disk drives, and the like.

Network interface(s) 210 (discussed in more detail above, in connection with FIG. 2) are one or more physical or logical elements that enable communication by operating environment 500 via one or more protocols or techniques.

Specialized hardware 542 represents any hardware or firmware that implements functions of electronic device 400. Examples of specialized communication hardware 460 include encoder/decoders (“CODECs”), decrypters, application-specific integrated circuits, secure clocks to support expiring digital licenses, and the like.

It will be appreciated that particular configurations of operating environment 500 or P2P Content Distribution System 101 may include fewer, more, or different components or functions than those described. In addition, functional components of operating environment 500 or System 101 may be implemented by one or more devices, which are co-located or remotely located, in a variety of ways. It will further be appreciated that although digital license distribution system/service 161 is described as being implemented using features or technologies associated with Microsoft® Windows Media® digital rights management systems that enable over-the-air acquisition of digital licenses 160 from network-side servers/services by communication devices, any now known or later developed digital rights management features or technologies may be used to implement aspects of digital license distribution system/service 161 (for example, OMA DRM 2.0 or another technology).

Various aspects of peer-to-peer digital content distribution transactions have been described. Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A computer-readable medium encoded with computer-executable instructions which, when executed by a processor, perform a method for distributing digital content between a source communication device operable by a source entity and a sink communication device operable by a sink entity, the digital content protected by a predetermined intellectual property right, the method comprising:
identifying a digital content item, the digital content item stored on a computer-readable medium accessible by the source communication device;
determining a proximity of the source communication device and the sink communication device;
if the source communication device and the sink communication device are determined to be in proximity, arranging for distribution, via a peer-to-peer communication session, of the digital content item from the computer-readable medium accessible by the source communication device to a computer-readable medium associated with the sink communication device; and
arranging for distribution of a digital license to the sink communication device, the digital license operative to grant a right to the sink entity under the predetermined intellectual property right,
wherein receipt of the digital license by the sink communication device triggers an e-commerce event.

2. The computer-readable medium according to claim 1, wherein the e-commerce event comprises one of arranging for the sink entity to authorize provision of consideration via the sink communication device, and arranging for the source entity to receive consideration via the source communication device, the consideration selected from the group consisting of: an exchange of a redeemable article; a promise to pay money; and a promise to perform a service.

3. The computer-readable medium according to claim 1, wherein the right granted to the sink entity is configured to enforce predetermined business rules, and wherein the right is selected from the group consisting of: the right to render the digital content item; the right to reproduce the digital content item; and the right to distribute the digital content item.

4. The computer-readable medium according to claim 1, wherein the method step of identifying a digital content item comprises identifying at least one selection option from among a plurality of selection options, the digital content item identified via the at least one selection option.

5. The computer-readable medium according to claim 4, wherein the method further comprises:
ascertaining an identity associated with one of the sink entity and the sink communication device,
wherein the plurality of selection options are based on the ascertained identity.

6. The computer-readable medium according to claim 5, wherein the method step of ascertaining an identity associated with one of the sink entity and the sink communication device comprises:
selecting at least one identity from among a plurality of identities; and
presenting the selected identity to the source communication device.

7. The computer-readable medium according to claim 6, wherein the method step of identifying the digital content item comprises:
receiving the plurality of selection options based on the presented identity; and
requesting access to the at least one of the plurality of selection options.

8. The computer-readable medium according to claim 5, wherein the method step of ascertaining an identity associated with one of the sink entity and the sink communication device comprises:
receiving a presented identity from the sink communication device.

9. The computer-readable medium according to claim 8, wherein the method step of identifying the digital content item comprises:
publishing the plurality of selection options based on the presented identity;
receiving a request from the sink communication device for access to the at least one of the published plurality of selection options; and
based on the request, identifying the digital content item.

10. The computer-readable medium according to claim 1, wherein the method step of arranging for distribution of a digital license occurs one of before and after the method step of arranging for asynchronous distribution of the identified digital content item.

11. The computer-readable medium according to claim 1, wherein the method step of arranging for distribution of a digital license comprises:
receiving a first message having a reference location associated with the digital license;
based on the reference location, transmitting a second message requesting the digital license;
in response to the second message, receiving the digital license;
storing the received digital license in a computer-readable memory accessible by the sink communication device; and
generating a status associated with the digital license,
wherein the status is usable to trigger the e-commerce event.

12. The computer-readable medium according to claim 11, wherein the method further comprises:
in response to the second message, receiving a transaction identifier; and
including the transaction identifier in the generated status, the transaction identifier usable to trigger the e-commerce event.

13. The computer-readable medium according to claim 11, wherein the reference location is accessible via a provider of wide-area network services to the sink entity.

14. A method for distributing a digital content item, the digital content item protected by a predetermined intellectual property right and stored in a computer-readable medium accessible by a source communication device, the method comprising:
receiving a distribution transaction notice, the distribution transaction notice comprising information regarding distribution of the digital content item via a peer-to-peer communication session between the source communication device and a sink communication device determined to be in proximity to the source portable communication device;
based on the distribution transaction notice, arranging for distribution of a digital license to the sink communication device, the digital license operative to grant a right, under the predetermined intellectual property right, to an entity authorized to operate the sink communication device;
collecting information regarding distribution of the digital license; and
based on the information collected regarding distribution of the digital license, arranging for a consideration transfer, the consideration transfer comprising one of consideration authorized for provisioning via the sink communication device, and consideration received via the source communication device.

15. The method according to claim 14,
wherein the step of arranging for distribution of a digital license to the sink communication device comprises arranging for a network-based service provider to distribute the digital license, one of before and after the digital content item is distributed between the source communication device and the sink communication device, and
wherein the network-based service provider is selected from the group consisting of: a provider of network services to the sink communication device; a provider of network services to the source communication device; and a third-party network service provider.

16. The method according to claim 14,
wherein the step of arranging for a consideration transfer comprises a provider of wide-area network services arranging for the consideration transfer, and
wherein the provider of wide-area network services is selected from the group consisting of: a provider of wide-area network services to the sink communication device; a provider of wide-area network services to the source communication device; and a third-party wide-area network service provider.

17. The method according to claim 14,
wherein the information regarding distribution of the digital content item and the information regarding the distribution of the digital license is selected from the group consisting of: identifying information associated with the digital content item; a number of distributions of the digital content item; a transcode event associated with the digital content item; an identity of the source communication device; an identification of consideration options receivable by the source communication device; a location of the source communication device; an original source of the digital content item; an identity of a provider of wide-area network services to the source communication device; an identity of a provider of wide-area network services to the sink communication device; an identity claim presented by the entity authorized to operate the sink communication device; an identification of consideration options providable by the sink communication device; information regarding the right granted under the predetermined intellectual property right; and information regarding exercise of the right granted under the predetermined intellectual property right.

18. A system for distributing a digital content item, the digital content item protected by a predetermined intellectual property right, the system comprising:
a computer-readable medium configured to store digital content distribution information and digital license distribution information,
the digital content distribution information comprising data regarding distribution of the digital content item via a peer-to-peer communication session between a source communication device and a sink communication device determined to be proximate to the source portable communication device, and
the digital license distribution information comprising data regarding distribution of a digital license to the sink communication device, the digital license operative to grant a right, under the predetermined intellectual property right, to an entity authorized to operate the sink communication device;
a digital content acquisition management engine configured to process the digital content distribution information;
a digital rights management engine configured to process the digital license distribution information and to arrange for distribution of the digital license to the sink communication device; and
a consideration management engine responsive to the digital content acquisition management engine and the digital rights management engine, the consideration management engine configured to arrange for a consideration transfer based on the digital content distribution information and the digital license distribution information, the consideration transfer comprising one of consideration provided via the sink communication device, and consideration received via the source communication device.

19. The system according to claim 18, wherein the system comprises a client-side operating environment.

20. The system according to claim 18, wherein the system comprises a server-side operating environment.
